(19) United States
(12) Patent Application Publication
(10) Pub. No.: US 2004/0255496 A1
(43) Pub. Date: Dec. 23, 2004

(54) Multi display board

(76) Inventor: Inman Youn, Seoul (KR)

Correspondence Address: SHERIDAN ROSS PC, 1560 BROADWAY, SUITE 1200, DENVER, CO, 80202

(21) Appl. No.: 10/481,569

(22) PCT Filed: Aug. 21, 2001
(86) PCT No.: PCT/KR01/01411

(30) Foreign Application Priority Data
Jun. 18, 2001 (KR) 200134289

(51) Int. Cl. G09F 13/22

(52) U.S. Cl. 40/544

(57) ABSTRACT

An advertising board capable of displaying advertising during both day and night hours. The board has an blocking panel having printed advertising material on one face layered on the front of PCB base plates installed with combination of LED devices. During night time hours the advertising board displays various moving advertising pictures through the several LED devices which are aligned with holes in the blocking panel.

### BACKGROUND OF THE INVENTION

1. Field of the Invention

This invention is regarding the multi-advertising signboard convertible day and night time with the complex functions of Para-flex, neon sign and electric signboard. In further detail, by attaching a set of printed and perforated boards at a certain distance on PCB board equipped with the grid combination of 3 primary colored LED, the printed front board functions as day time advertising board, while the electric LED backdrop board displays various moving pictures through perforated front board in night time. Thus the purpose of this invention is to enhance the advertising effectiveness by a multi-convertible advertising board.

In modern society, as the advertisement functions as an important means of information communication to the people and the communication of information becomes faster, various means of information communication have been developed. Accordingly, the clients are seeking faster and various media to promote their advertising information to the customers.

2. Discussion of Related Art

As known to general public, the conventional advertising display boards for specific products and companies were placed on the roof of building, inside of subway station and on the road. The main structure of the board, as shown on FIG. 6 of the conventional Para-flex, was made of squared supporting panel (42). The several luminescent lamps (44) were placed at certain intervals on the face of the supporting panel (42) and on the perimeter of the panel reflecting panels are placed vertically (46). Reflecting plates (48) are installed on the reflecting panel and advertising printed sheet is attached on the front of the reflecting panels (46).

The conventional Para-flex advertising board above works by rear projection of the lights of luminescent lamps installed on the supporting panel, and the effectiveness of advertising by rear reflecting plate is very low since the direction of lights of the luminescent lamps above is not projecting toward for a specific direction. Accordingly, for the front advertising printed sheet to meet a required advertisement standard, it requires several amount of back lightings of luminescent lamps, which cause a certain amount of economic burden to the client as a result.

In addition, since the para-flex advertising board above is installed as a type that advertising printed sheet is attached on the certain size of case, the client should not only replace himself the board if he intend to advertise other contents of advertisement, but also the board could not attract the visual attraction and interest from the passerby since the advertising printed sheet usually has been exhibited too long period without any movement and change of content. Thus, it caused decrease of the effectiveness of advertisement. In case of the advertisement boards installed on the roof or on the wall, the supporting panel becomes large in proportion to the size of advertising printed sheet that it causes not only difficulties in transporting and installing, but also several problems like risk of incidents in installing and shortage of life cycle because or transformation by surrounding weather conditions (temperature, rain and wind, etc).

Even such electric advertising boards as CRT (cathode-ray tube) and PDT were introduced recently to complement the defects mentioned above, but most of the electric boards are adopting changed type LED device because of the limit of size of CRT and PDT.

This type of electric board, as is changing from large to mid size, low to high density and advertisement-oriented to means of information communication, is installed around the plaza of large number of public passing from the cross road of large traffic passing.

However, since the electric board using CRT monitors is advertising only still displays and cannot attract present-day people's interest with such still advertising displays, it has a problem that it cannot perform its public relations and advertisement function satisfactorily.

The life of the electric board above using LED is over 70,000 hours if it is working 6 hours daily and the luminosity of it is 2,000 cd/cm2.

It has the advantage of digital display with LED devices placed at 62.5 m/m intervals.

However, the conventional electric board is displaying moving pictures through controller that is transforming and controlling video signals input from video signal output devices. The controller has such disadvantages as complicated system and large system size since the device have to transform and control video signals live.

In addition, the system required such complicated systems as LED display board, personal graphic computer, video signal input, video output server and other programs/devices to display pictures. The effectiveness of the system was not so satisfactory compared to the excessive investment considering such facts that in the event of system breakdown, it required long repairing time and equipments, and decrease of visual conspicuousness of its display in daytime.

Meanwhile, the effective value of neon sign is below expectation because of impossibility of program change.

### SUMMARY OF THE INVENTION

The invention is to solve the defects mentioned before and the purpose of this invention is to providing the multi-advertising signboard convertible day and night time with the complex functions of para-flex, neon sign and electric sign board. In further detail, by attaching in consecutive orders layers of printed boards punched matching to the LED light to the front of several PCB boards equipped with the grid combination of 3 primary colored LED, the printed front board functions as day time advertising board, while the electric LED backdrop board displays various moving pictures through perforated front board in night time. Thus the purpose of this invention is to enhance the advertising effectiveness by a multi-convertible advertising board.

Another purpose of this invention is to providing advertising board that projects brighter luminosity with quite less amount of electricity consumption compared with that of existing display systems equipped with several luminescent lamps per unit Sq.m of Para-flex.

### BRIEF DESCRIPTION OF THE ATTACHED DRAWINGS

FIG. 1 is an deal perspective view of disassembled invention

FIG. 2 is a rear perspective view of panel body

FIG. 3 is a rear perspective view of blocking panel

FIG. 4 is a combination perspective view of panel body

FIG. 5 is an perspective view of an alternative embodiment of the invention

FIG. 6 is a view of the prior advertising board

### DETAILED DESCRIPTION OF PREFERRED EMBODIMENT

The drawings below show the most desirable example of a structure of the invention. Above all, the reference number of each part is referred as same number in explaining other drawings.

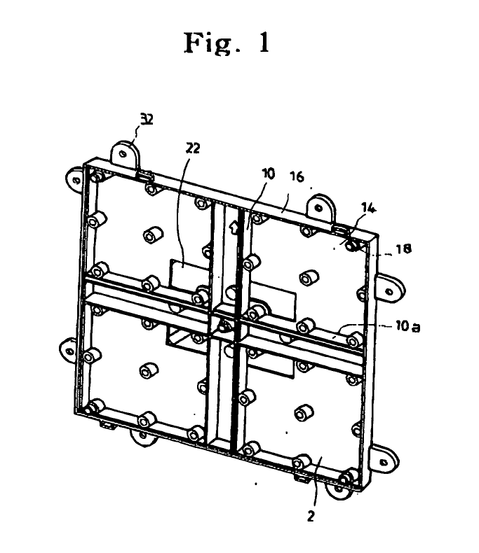

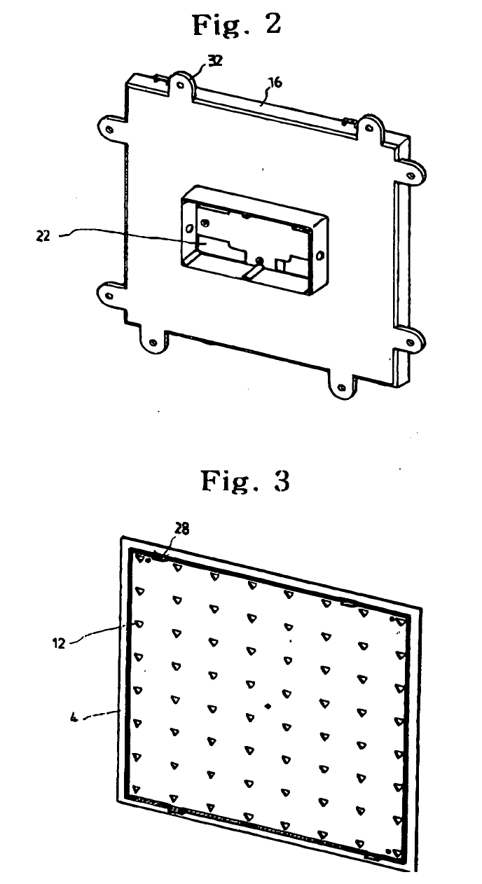

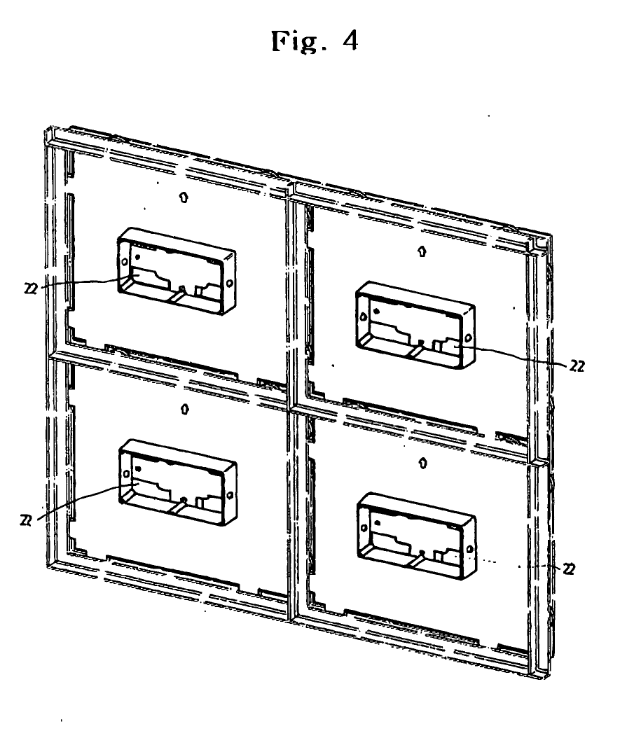

As shown on FIG. 1 and FIG. 4, the present invention consists of PCB base plate (6) equipped with LED (Light Emitting Diode) of three primary color placed at certain intervals and in grid pattern, panel body (2) fastening several PCB panels (6) and perforated blocking panel (4) printed with advertising content on the face of it.

Above panel body forms several compartments (14) by vertical (10), lateral (10a) and outside wall (16). The center of the compartments (14) is perforated for outlet (22) of electric code connected to LED (20) inserted on the PCB base plate (6) and fastened on it. The outside wall (16) is formed with several fixed protrusions (32) to fasten panel body (2) to the walls or to the frame supporting the advertising panel.

At this time, the fixed protrusions are place mingled in all direction to fasten both the frame and panel body tightly.

The above PCB base plates (6) fastening LED are fastened to the panel body (2) by tightening connecting bolts to the several inserted protrusions (18) in compartments which are spacing out the PCB base plates (6) and walls at certain intervals.

At this time, the gaps between panel body (2) and base plate (6) should be filled with silicon lest the rain and humidity should penetrate the gaps and damage the parts of the system.

The display of the system is made by combination of primary colored LED fastened to PCB base plate and LED can be fastened to the base plate in grid type or other pattern in accordance with the display contents of advertisement.

At this time, the LED (20) inserted in base plate should be coated with required thickness of silicon from the front of the base plate that it cannot be exposed to outside environment and can be protected from vibration, humidity and weather.

The blocking advertising panel (4) attached to the panel body (2) and placed on the face of base plate (6) is punched with holes (12) matching to LEC light lest the quality of display should decrease because of diffusion of LED light. The four corners of back of the blocking panel (4) are provided with connection protrusions (24) for connection with walls (16) of the panel body (2) and on the top and bottom of it are provided with connecting holes (26) to connect with fastening protrusion (28) on the panel body that LED (20) protrude the face of the advertising blocking panel (4).

At this time, the face of the blocking panel (4) printed with required advertisement can be used as daytime advertising board, while LED light display can be used for various moving picture advertising board in night time.

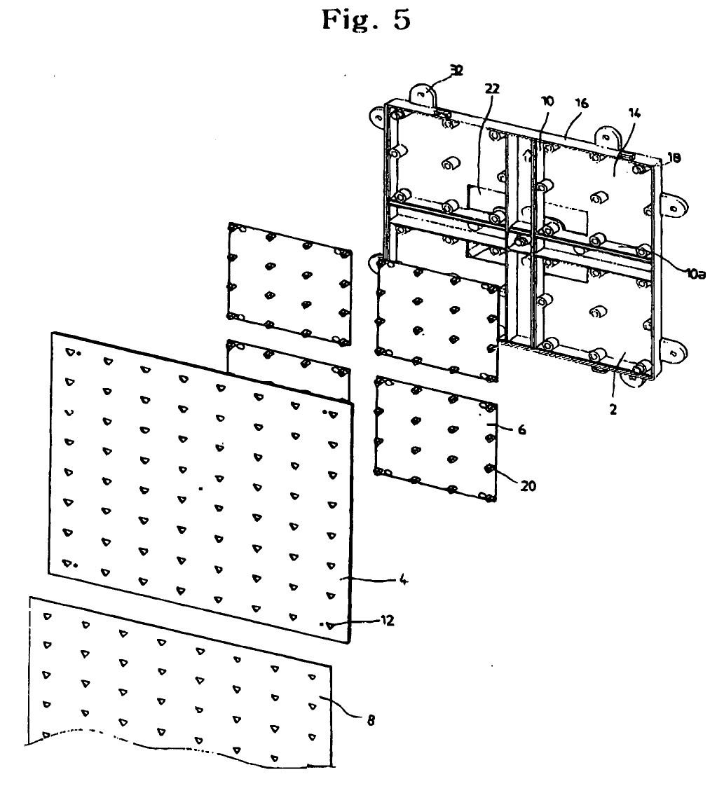

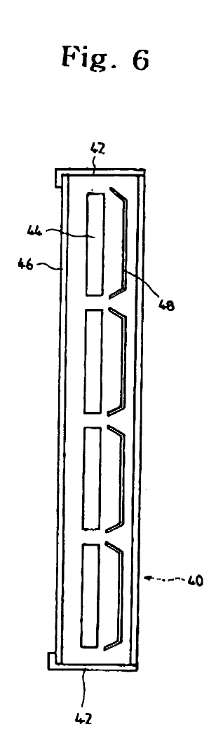

The FIG. 5, as an alternative to this invention, shows that the client can change easily the advertisement by laying another advertising board (8) on the existing blocking panel (4).

As described above, this invention is made by the combination of three primary colored LED devices (20) fastened on PCB base plate (6) at certain intervals and coated with silicon for tight protection and fastening of them (20) on the base plate (6).

After PCB base plate (6) equipped with LED (20) is inserted into the compartment, the gaps between wall (16) and the base plate (6) are filled with silicon for complete water-tightening. The electric code connected to the PCB base plate (6) is extracted (22) for connection with input & output terminal for display of advertisement and the layered advertising blocking panel (4) that protecting LED (20) light from diffusing is used for daytime advertisement effectively.

At this moment, the blocking panel (4) is designed as removable with the combination of connection protrusions and holes that the user can replace it (4) easily and place another advertising board (8) on the face of it.

In addition, the size of displaying board can be changed freely with the combination of another panel bodies (2) by the necessity of the client when fastening the mingled and fixed protrusions (32) installed on the panel body (2) to the wall or supporting frame.

Accordingly, the invention displays in daytime printed advertising board and in night time moving advertising pictures by display of several LED devices that are installed in PCB base plate (6) and are displaying output signals from the video output signal device.

At this moment, the PCB base plate (6) equipped with numerous LED devices placed at certain intervals displays moving advertising pictures by the combination of three primary colored LED radiating as a group.

1-4. (Canceled).

5. An advertising signboard for day and night time use, comprising:
a base plate;
a plurality of primary colored LED devices placed in a predetermined pattern on said base plate; and
a blocking panel having a plurality of openings matching the location of said LED devices and located adjacent to said base plate such that light produced from said LED devices is visible through said openings.

6. The advertising signboard, as claimed in claim 5, further comprising:
a panel body, wherein at least two base plates are interconnected with said panel body, and wherein said panel body is divided into several compartments by vertical, lateral, and outside walls.

7. The advertising signboard, as claimed in claim 5, wherein said base plate and blocking panel are mounted to a panel body, and
wherein said blocking panel includes connecting protrusions operable to connect said blocking panel to said panel body and enclose said base plate.

8. The advertising signboard, as claimed in claim 5, wherein said blocking panel includes a printed advertising sheet on at least one face.
